(19) United States
(12) Patent Application Publication
(10) Pub. No.: US 2015/0062119 A1
(43) Pub. Date: Mar. 5, 2015

(54) IMAGE PROCESSING DEVICE, 3D-IMAGE DISPLAY DEVICE, METHOD OF IMAGE PROCESSING AND PROGRAM PRODUCT THEREOF

(71) Applicant: KABUSHIKI KAISHA TOSHIBA, Tokyo (JP)

(72) Inventors: Norihiro NAKAMURA, Kawasaki Kanagawa (JP); Takeshi MITA, Yokohama Kanagawa (JP)

(21) Appl. No.: 14/469,663

(22) Filed: Aug. 27, 2014

(30) Foreign Application Priority Data
Aug. 29, 2013 (JP) 2013-178561

(51) Int. Cl. G06T 15/06; G06T 19/20

(52) U.S. Cl. CPC G06T 15/06; G06T 19/20; G06T 2200/04
USPC 345/419

(57) ABSTRACT

A 3D-image display device according to embodiments can display a 3D-image. The device may comprise a display panel, an optical aperture, a divider, a generator, and a data processor. The display panel may include a plurality of sub-pixels. The optical aperture may be placed opposite the display panel. The divider may divide a region on the display panel into division numbers differing from each other to generate small regions. The generator may generate 3D-images based on the small regions by using a model data in which a shape of a 3D object is represented, each 3D-image corresponding to one of the division numbers. The data processor may select a 3D-image to be displayed on the display panel by evaluating the 3D-image corresponding to each division number.

### CROSS-REFERENCE TO RELATED APPLICATION(S)

This application is based upon and claims the benefit of priority from the Japanese Patent Application No. 2013-178561, filed on Aug. 29, 2013; the entire contents of which are incorporated herein by reference.

### FIELD

Embodiments described herein relate generally to an image processing device, a 3D-image display device, a method of image processing and a program product thereof.

### BACKGROUND

Recently, in a technical field of a medical diagnostic imaging device such as an X-ray CT (computed tomography), a MRI (magnetic resonance imaging), an ultrasonograph, or the like, a device capable of generating a 3D-medical image (volume data) has been put to practical use. Furthermore, a technique of rendering volume data from arbitrary viewpoints has also been put to practical use. Accordingly, in recent years, a technique of displaying an image on a 3D-image display stereoscopically by rendering volume data from a plurality of viewpoints is discussed.

According to the 3D-image display, the observer can directly view a 3D-image without special glasses. Such 3D-image display can display a plurality of images with different viewpoints (hereinafter each image will be referred to as a parallax image). Light rays of displayed parallax images are controlled by an optical aperture (parallax barrier, lenticular lens, or the like, for instance). Therefore, the images to be displayed are required that pixels thereof are rearranged so that an intended image can be seen from an intended direction when viewing the image through the optical aperture. In the followings, a method of such rearrangement will be referred to as a pixel mapping.

As described above, the light rays controlled by the optical aperture and the pixel mapping tailored to the optical aperture are introduced to both eyes of the observer. At this time, when a position of the observer is appropriate, the observer can view a 3D-image. A range where the observer can view a 3D-image will be referred to as a visible range.

However, although the number of viewpoints for generating parallax images is predetermined, in general, it is not necessarily provided a sufficient number of viewpoints for deciding brightness information about all pixels of a display panel. Therefore, a brightness value of a pixel of which brightness information is not decided from parallax images are decided by a method of using a brightness value of a pixel in a parallax image of which viewpoint is closest to a viewpoint of a parallax image including the pixel without the brightness information, a method of executing a linear interpolation based on brightness information of a parallax image with a viewpoint near the viewpoint of the parallax image including the pixel without the brightness information, or the like.

However, in the method in that absent information is obtained by a linear interpolation, because parallax images with different viewpoints are blended, phenomenons such that an edge in the image being naturally single is seen double or more (hereinafter referred to as multiple image), the whole image is blurred, or the like, may be provided.

For example, a method where the number of viewpoints are not predetermined, after deciding a combination of sub-pixels and lenses based on a viewpoint of the observer, directions of light rays emitted through the lenses from the sub-pixels are calculated based on position relationships therebetween, and a 3D model is rendered in faithful accordance with the directions of the light rays can be considered. In this way, because a linear interpolation is not necessary, it is possible to realize a high-quality stereoscopic display. However, because the calculation and the rendering are executed for every sub-pixel independently, a calculation cost becomes greater depending on a resolution of a panel, and there may be a case where it is impossible to execute a real-time rendering.

### BRIEF DESCRIPTION OF THE DRAWINGS

FIG. 1 is a block diagram showing a 3D-image display device according to a first embodiment;

FIG. 2 is an elevation view showing an outline structure of a display shown in FIG. 1;

FIG. 3 is an illustration showing a relationship between an optical aperture and a display element of the display shown in FIG. 2;

FIG. 4 is an illustration for explaining a 3D-pixel region according to the first embodiment;

FIG. 5 is an illustration for explaining quantization unit regions and a sub-pixel group;

FIG. 6 is an illustration showing a position relationship between a panel and viewpoints;

FIG. 7 is an illustration showing a position relationship between the rendering space and a starting position and an ending position of a representative ray;

FIG. 8 is an illustration showing a position relationship between the rendering space and the starting position and the ending position of the representative ray;

FIG. 9 is an illustration showing a position relationship between a center of the panel and a reference point of the 3D-pixel region;

FIG. 10 is an illustration for explaining a relationship between each sub-pixel and a brightness value in a sub-pixel group;

FIG. 11 is a flowchart showing a total operation of an image processing device according to the first embodiment;

FIG. 12 is a flowchart showing an example of a 3D-image generation process according to the first embodiment;

FIG. 13 is block diagram showing a 3D-image display device according to an alternate example 1;

FIG. 14 is an illustration for explaining a process of a second calculator according to the alternate example 2;

FIG. 15A is an illustration showing a first position relationship between a panel and an optical element;

FIG. 15B is an illustration showing a second position relationship between a panel and an optical element;

FIG. 15C is an illustration showing a third position relationship between a panel and an optical element;

FIG. 16 is a block diagram showing a 3D-image display device; and

FIG. 17 is an illustration showing an example of a screen displayed on a display.

### DETAILED DESCRIPTION

Exemplary embodiments of an image processing device, a 3D-image display device, a method of image processing and a program product thereof will be explained below in detail with reference to the accompanying drawings.

### First Embodiment

Firstly, an image processing device, a 3D-image display device, a method of image processing and a program product thereof according to a first embodiment will be described in detail.

Structure

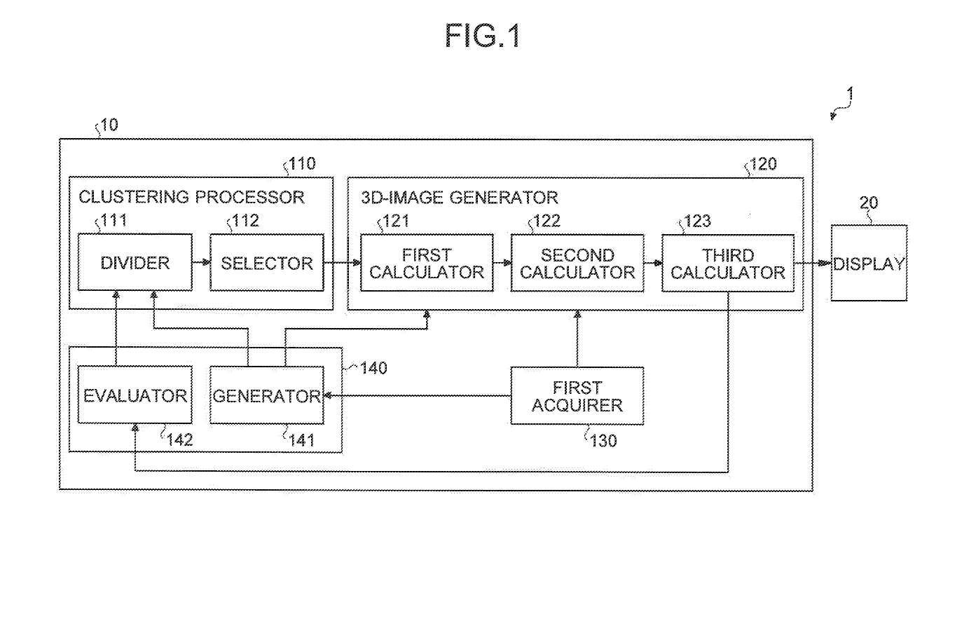

FIG. 1 is a block diagram showing a structure example of a 3D-image display device according to the first embodiment. As shown in FIG. 1, the 3D-image display device 1 has an image processing device 10 and a display 20.

The image processing device 10 includes a clustering processor 110, a 3D-image generator 120, a first acquirer 130 and a data processor 140. The units exampled in FIG. 1 can directly or indirectly communicate with each other via a network. Furthermore, each units exampled in FIG. 1 can transmit and receive a medical image, or the like, to or from the other. Any kind of network can be applied to the 3D-image display device 1. For example, it is possible that the units can communicate with each other via a LAN (local area network) installed at a hospital. Furthermore, for example, it is also possible that the units can communicate with each other via a network (including a cloud computing) such as the internet, or the like.

The clustering processor 110 includes a divider 111 and a selector 112. The clustering processor 110 executes a process of selecting sub-pixels of which light rays controlled by an optical aperture are emitted to similar directions as a single group (hereinafter referred to as a sub-pixel group). The divider 111 calculates parameters (hereinafter referred to as region parameters) indicating ranges on a panel corresponding to sub-pixel groups based on a preset division number. The selector 112 selects sub-pixels based on the range parameters.

The data processor 140 generates a second model data (hereinafter referred to as an evaluation model data) representing features of a model data, and transmits a division number (hereinafter referred to as an evaluation-targeted division number) for generating a 3D-image for evaluation to the clustering processor 110. Furthermore, the data processor 140 transmits the generated evaluation model data to the 3D-image generator 120. Moreover, the data processor 140 acquires one or more 3D-images generated by the 3D-image generator 120, and decides a division number which should be used by the clustering processor 110 by evaluating similarity between a 3D-image being a reference thereamong and the other 3D-images.

The image processing device 10 includes a first calculator 121, a second calculator 122 and a third calculator 123. The first calculator 121 calculates directions of light rays (hereinafter referred to as representative ray direction) representing sub-pixel groups. The second calculator 122 calculates starting positions and directional vectors (hereinafter referred to as ray information) of light rays based on the representative ray directions, and calculates a brightness value of each sub-pixel based on the model data and the ray information. The third calculator 123 generates a 3D-image by calculating a brightness value of each sub-pixel in a corresponding sub-pixel group based on the calculated brightness value. The generator 3D-image is inputted to the display 20 and displayed on the display 20. Thereby, the 3D-image is displayed to an observer. Here, the model data in the description is assumed as a volume data commonly used as a 3D-medical image data.

Next, each unit (device) shown in FIG. 1 will be described in more detail.

/Display

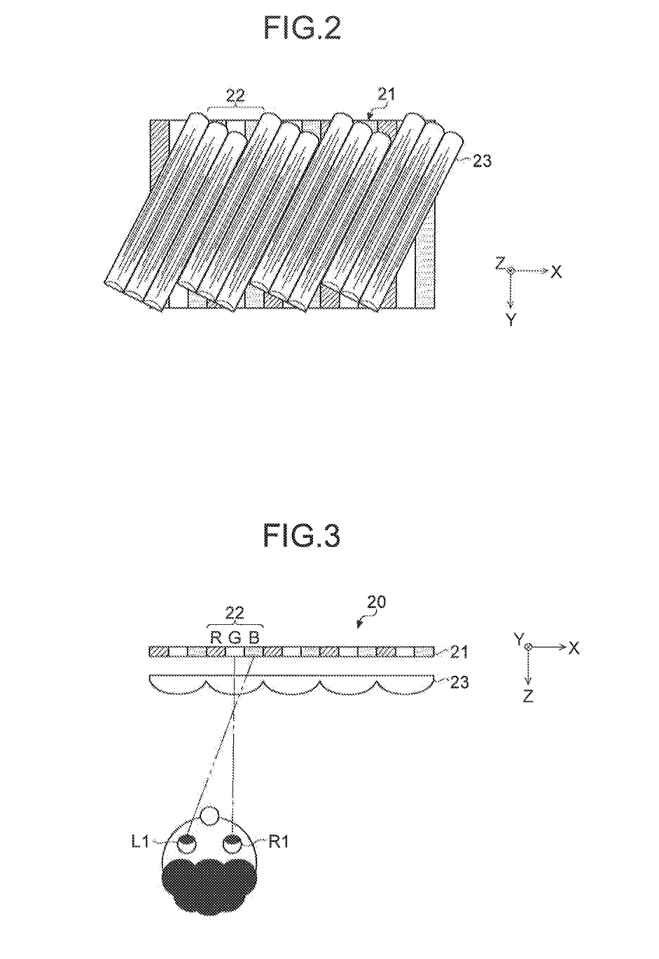

FIG. 2 is an evaluation view showing an outline structure example of the display shown in FIG. 1. FIG. 3 is an illustration showing a relationship between an optical aperture and a display element of the display shown in FIG. 2. In the following, a range (region) where the observer can view a 3D-image displayed on the display 20 stereoscopically will be referred to as a visible range.

As shown in FIGS. 2 and 3, the display 20 has, on a real space, a display element (hereinafter referred to as a panel) 21 in which a plurality of pixels 22 are arrayed in a matrix in a plane, and an optical aperture 23 located at the front of the panel 21. The observer views a 3D-image displayed on the display 20 by observing the display element (panel) 21 through the optical aperture (also referred to as an aperture controller) 23. In the following, a center of a screen (also referred to as a display surface) of the panel 21 is defined as an origin, a horizontal direction of the display surface is defined as an X-axis, a vertical direction of the display surface is defined as a Y-axis, and a normal direction of the display surface is defined as a Z-axis. In such case, a height direction indicates a direction of the Y-axis. However, an arrangement of a coordinate system with respect to the real space is not limited to such arrangement.

The panel 21 displays a 3D-image as to be able to view the 3D-image stereoscopically by the observer. As the panel 21, a direct-view 2D-display such as an organic EL (electro luminescence) display, a LCD (liquid crystal display) and a PDP (plasma display panel), a projection display, or the like, can be used.

Each pixel 22 is defined by a set including a sub-pixel of each color of RGB as a unit, for instance. Sub-pixels of RGB included in a single pixel 22 are arrayed along the X-axis, for instance. However, the arrangement is not limited to the above example while the arrangement of each pixel 22 can be deformed so that sub-pixels of four colors are grouped into a single pixel 22, or four sub-pixels including an additional sub-pixel of B component in addition to the three sub-pixels of RGB, or the like.

The optical aperture 23 emits light rays radiated forward from pixels 22 of the panel 21 toward certain directions via apertures. As the optical aperture 23, for instance, an optical element such as a lenticular lens, a parallax barrier, or the like, can be used. For example, a lenticular lens has a structure in that a plurality of fine spindly cylindrical lenses are arrayed in a shorter direction thereof.

As shown in FIG. 3, the observer located in the visible range of the display 20 will, through the optical aperture 23, observe sub-pixels of G component in the pixels 22 of the panel 21 with a right eye R1 and observe sub-pixels of B component in the pixels 22 of the panel 21 with a left eye L1, for instance. Therefore, as shown in FIG. 2, the optical aperture 23 is arranged so that a longitudinal direction of each optical element constructing the optical aperture 23 is inclined at a certain degree (8 degree, for instance) with respect to the panel 21 (the Y-axis, for instance). The display 20 can let the observer view an image stereoscopically by displaying a 3D-image of which a pixel value of each sub-pixel is calculated based on a variation of a ray direction caused by the inclination of the optical elements.

/Image Processing Device

Next, structures of the units of the image processing device 10 shown in FIG. 10 will be described in detail with reference to the accompanying drawings.

//First Acquirer

The first acquirer 130 in the image processing device 10 acquires a model data from external. The external is not limited to a storage media such as a hard disk, a CD (compact disc), or the like, and it can include a server connected via a network, or the like. As the model data, a volume data, a spatial partitioning model, a boundary representation model, or the like, can be used.

As the server connected to the first acquirer 130 via a network, a medical diagnostic imaging unit, or the like, can be applied. The medical diagnostic imaging unit is a device capable of generating a 3D-medical image data (volume data). As the medical diagnostic imaging unit, for instance, an X-ray diagnostic apparatus, an X-ray CT scanner, a MRI device, an ultrasonography, a SPECT (single photon emission computed tomography) device, a PET (positron emission computed tomography) device, a SPECT-CT scanner integrating a SPECT scanner and a CT scanner, a PET-CT scanner integrating a PET device and a CT scanner, a combination thereof, or the like, can be applied.

The medical diagnostic imaging unit generates a volume data by imaging a subject. For example, the medical diagnostic imaging unit collects data such as projection data, MR signals, or the like, by imaging a subject, and generates a volume data by reconstructing a plurality (300 to 500, for instance) of slice images (transverse section images) along a body axis of the subject from the collected data. That is, the plurality of slice images imaged along a body axis of a subject are a volume data. However, it is also possible to use projection data or MR signals of a subject obtained by the medical diagnostic imaging unit as a volume data. A volume data generated by the medical diagnostic imaging unit may include images of observation objects in clinical practice (hereinafter referred to as objects) such as bones, vessels, nerves, growths, or the like. Furthermore, a volume data may include data in which isosurfaces are represented by geometric elements such as polygons, curved surfaces, or the like.

//Clustering Processor

Next, the units in the clustering processor 110 of the image processing device 10 will be described.

///Divider

The divider 111 defines ranges (quantization unit regions) for specifying sub-pixels to be included in each sub-pixel group on the panel 21 based on the division number given by the data processor 140. In particular, the divider 111 calculates a width Td of regions, which is defined by dividing each 3D-pixel region, along the X-axis based on a division number Dn. An initial value of the division number can be an arbitrary natural number. For example, it is possible to define a preset maximum division number as the initial division number.

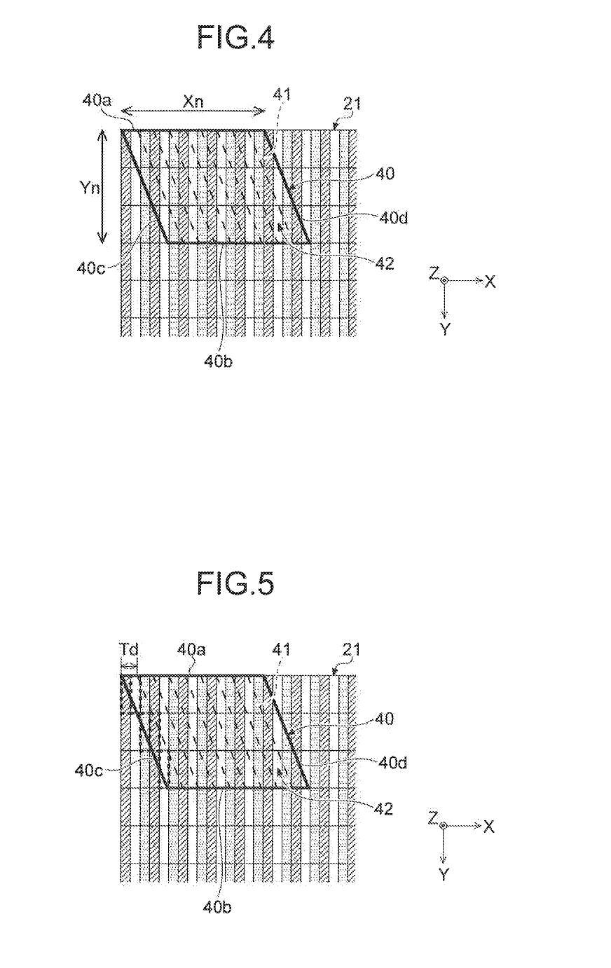

Here, a 3D-pixel region will be explained. FIG. 4 is an illustration for explaining a 3D-pixel region. As shown in FIG. 4, a 3D-pixel region 40 is a region with a horizontal width Xn and a vertical with Yn when the X-axis is defined as a reference with respect to a drawing direction of the optical aperture 23. Each 3D-pixel region 40 is divided into a Dn number of regions (quantization unit regions) so that parting lines 41 are arranged parallel to the drawing direction of the optical aperture 23. For example, when the division number Dn is 8, seven parting lines 41 are arranged. Each parting line 41 is parallel to side lines 40c and 40d each of which have a Y-axis component among boundary lines of the 3D-pixel region 40. Adjacent parting lines 41 are arranged at regular intervals. An interval Td between the adjacent parting lines 41 can be obtained by the following formula (1), for instance. Here, the interval Td is a length in a direction parallel to the X-axis.

$$Td = \frac{Xn}{Dn} \qquad ( 1 )$$

A distance of each parting line 41 from the side line 40c which is a boundary line with a smaller X-coordinate among the boundary lines of the 3D-pixel region 40 is constant. This is the same for all of the parting lines 41. Therefore, ray directions of lights emitted through each parting line 41 become the same direction. In the following, regions 42 surrounded by one of the side line 40c and 40d of the 3D-pixel region 40, a parting line 41 adjacent to the one of the side line 40c and 40d, and boundary lines parallel to the X-axis of the 3D-pixel region 40 (hereinafter referred to as an upper line 40a and a lower line 40b), and regions 42 surrounded by adjacent two parting lines 41, the upper line 40a and the lower line 40b are defined as units for specifying sub-pixel groups, respectively, and each region 42 is referred to as the quantization unit region. Information about calculated quantization unit regions 42 is inputted to the selector 112 as region parameters indicating region corresponding to sub-pixel groups on the panel 21.

There is a case where a region with an insufficient size for forming a 3D-pixel region 40 is remained as a result of dividing the panel 21 into the 3D-pixel regions 40. In such case, it is possible that the remainder is assumed as a part of a 3D-pixel region 40 adjacent to the remainder in a lateral direction, the 3D-pixel region 40 with the remainder is defined so that an expanded region (i.e., the remainder) in the 3D-pixel region 40 is protruded outside the panel 21, and the 3D-pixel region 40 with the remainder is processed by the same processes with the other 3D-pixel regions 40. As another method, it is also possible to arrange plane color such as white, black, or the like, to the remainder.

In FIG. 4, although the horizontal width Xn is defined as the same with a width along the X-axis of each optical element (hereinafter referred to as lens or barrier) constructing the optical aperture 23, the horizontal width Xn does not have to be the same with the width. Furthermore, in the formula (1), although the interval Td is defined as a constant interval, it is not an essential structure. For example, it is also possible that the interval Td is varied depending on a position on the panel 21 so that the interval Td becomes greater as it is closer to the side line 40c or 40d of the 3D-pixel region 40, in other words, the interval Td becomes smaller as it is closer to a center of the 3D-pixel region 40.

In FIG. 4, although a case where a boundary of the lens (barrier) constructing the optical aperture 23 corresponds to a left top corner of the panel 21 is shown, also there is a case where the boundary of the lens is shifted from the left top corner of the panel 21. In such case, positions of 3D-pixel regions 40 on the panel 21 is shifted by the same length as the shift between the boundary and the left top corner of the panel 21. For a remainder region at a left or right periphery caused by the shift of the 3D-pixel region, as with the above-described processes, it is possible to apply the method of expanding the adjacent 3D-pixel region 30, the method of arranging plane color to the remainder, or the like.

///Selector

The selector 112 selects one or more sub-pixels of which ray directions can be treated as the same direction based on the quantization unit regions 42 indicated by the inputted range parameters, and groups the selected sub-pixels into a single sub-pixel group. In particular, as shown in FIG. 5, regarding a certain quantization unit region 42, the selector 112 selects every sub-pixel each of which representative point is included in the certain quantization unit region 42. The representative point may be a preset point such as a left top corner, a center, or the like, of each sub-pixel, for instance. In FIG. 5, a case where the representative point is defined as a left top corner of each sub-pixel is exampled.

As selecting sub-pixels, the selector 112 obtains an X-coordinate Xt of the side line 40c of the quantization unit region 42 for each Y-coordinate Yt belonging to a range of the vertical width Yn of the quantization unit region 42. The whole sub-pixels of which representative points are included in the range (Xt+Td) with the interval Td from the X-coordinate Xt are targeted sub-pixels for grouping. Therefore, when the X-coordinate Xt is defined by a sub-pixel basis, for instance, an integer values included within the range (Xt+Td) are X-coordinates of selected sub-pixels. For example, when Xt=1.2, Td=2 and Yt=3, coordinates of selected sub-pixels are (2,3) and (3,3). By executing such selection for every Y-coordinate Yt within the range with the vertical width Tn, the selector 112 selects every sub-pixel each of which representative point is included in the range for each quantization unit region, and defines the selected sub-pixels as a sub-pixel group corresponding to each quantization unit region.

//3D-Image Generator

Next, the units in the 3D-image generator 120 of the image processing device 10 will be described.

///First Calculator

The first calculator 121 calculates a ray number of each sub-pixel belonging to each sub-pixel. The first calculator 121 also calculates one representative ray number for each sub-pixel group based on the calculated ray numbers of the sub-pixels, and calculates information about representative ray (hereinafter referred to as representative ray information) based on the calculated representative ray number.

Here, the ray number is a direction indicated by a light ray emitted from each sub-pixel of the panel 21 through the optical aperture 23, and it may be decided at a planning phase of the display 20. The ray number can be calculated by first defining the number of reference viewpoints as N, and a 3D-pixel region 40 (a region with the horizontal width Xn and the vertical width Yn) while the X-axis is defined as a reference with respect to the drawing direction of the optical aperture 23, and then defining a direction in which light emitted from a position corresponding to the side line 40c at a negative side of the 3D-pixel region 40 travels as ‘0’, and a direction in which light emitted from a position away from the side line 40c by as much as Xn/N as ‘1’, in that order. Thereby, for a light ray of the light emitted from each sub-pixel, a number representing the direction indicated by the light through the optical aperture 23 is given as a ray number. Here, it is assumed that the preset reference viewpoints are arrayed along a line crossing a perpendicular line passing through a center O of the panel 21 vertically and being parallel to the X-axis at regular intervals, for instance.

However, when a width of each optical element, which is a structure component of the optical aperture 23, along the X-axis does not correspond to the horizontal width Xn, the ray numbers representing the ray directions become serial numbers only in the same 3D-pixel region 40. That is, a direction of a ray number in one 3D-pixel region 40 does not coincide with a direction of the same ray number in the other 3D-pixel region 40. However, when similar ray numbers are grouped into a single set, light rays corresponding to ray numbers belonging to each set may focus on different positions (hereinafter referred to as focus positions) by each set. That is, light rays focusing on the same focus position have the same ray number, and light rays belonging to a set of ray numbers different from the light rays focusing on the same focus position will focus on the same focus position different from the focus position of the light rays focusing on the same focus position.

On the other hand, when a width of each optical element, which is a structure component of the optical aperture 23, along the X-axis correspond to the horizontal width Xn, light rays with the same ray number become infinitely parallel to each other. Therefore, light rays with the same ray number in all of the 3D-pixel regions 40 will indicate the same direction. In addition, focus positions of the light rays corresponding to ray numbers belonging to each set will be located at a position infinitely separated from the panel 21.

The reference viewpoints are a plurality of viewpoints, which may be referred to as cameras in a field of computer graphics, defined on a space for rendering (hereinafter referred to as a rendering space) at regular intervals. As a method for assigning ray numbers to a plurality of reference viewpoints, it is applicable that ray numbers are assigned to reference viewpoints in order from the very right while the smallest ray number is assigned to the rightmost reference viewpoint. In such case, to the rightmost reference viewpoint, a ray number ‘0’ is assigned, and to the next rightmost reference viewpoint, a ray number ‘1’ is assigned.

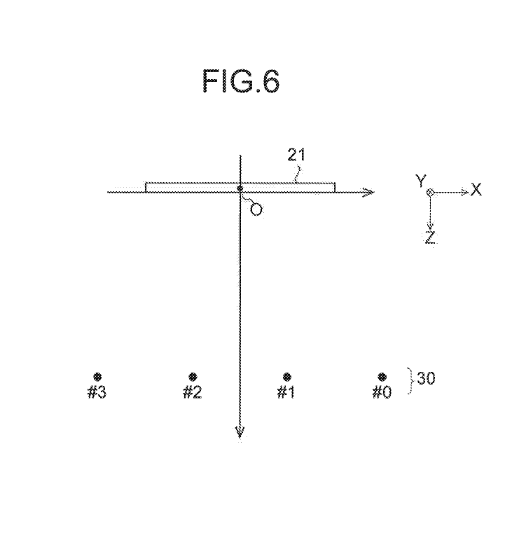

FIG. 6 is an illustration showing a position relationship in a horizontal direction between a panel and viewpoints in the case where ray number are assigned to reference viewpoints in order from the rightmost reference viewpoint among the reference viewpoints arraying along the horizontal direction (the X-axis direction) with respect to the panel (the rendering space) while the smaller ray number is assigned to the rightmost reference viewpoint. As shown in FIG. 6, when four reference viewpoints 30 from #0 to #3 are arranged to the panel 21 (the rendering space 24), integral ray numbers ‘0’ to ‘3’ are assigned to the four reference viewpoints 30 in order from the very right reference viewpoint #0. A parallax becomes greater as an interval between adjacent reference viewpoints 30 is greater, and thereby, it is possible to display more stereoscopic 3D-image for the observer. That is, by adjusting the interval between the reference viewpoints #0 to #3, it is possible to control a projection amount of the 3D-image.

When ray numbers of an n number of sub-pixels included in a sub-pixel group are defined as v₁ to vₙ, a representative ray number v′ can be obtained by the following formula (2), for instance. In the formula (2), v₁ to vₙ indicate ray numbers of sub-pixels in a sub-pixel group, and n indicates the number of sub-pixels belonging to the sub-pixel group.

$${v}^{′} = \frac{1}{n} {Σ}_{n} {v}_{n} \qquad ( 2 )$$

However, a method for obtaining a representative ray number of each quantization unit region 42 is not limited to a method using the formula (2). For example, instead of using a simple average such as a medium value of ray numbers as a representative ray number as in the method using the formula (2), it is possible to apply various kinds of methods such that the representative ray number is defined using a weighted average of ray numbers. In a case of using a weighted average, a weight may be predetermined based on a kind of a color component of a sub-pixel, for instance. In such case, because generically luminosity of G component is high, it is applicable to make a weight for a ray number of a G-component sub-pixel greater.

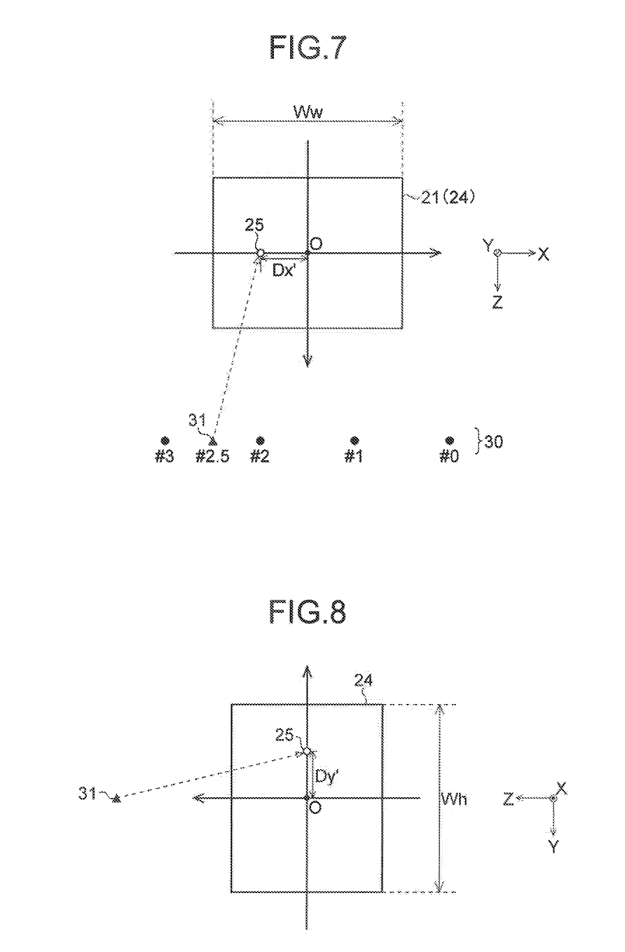

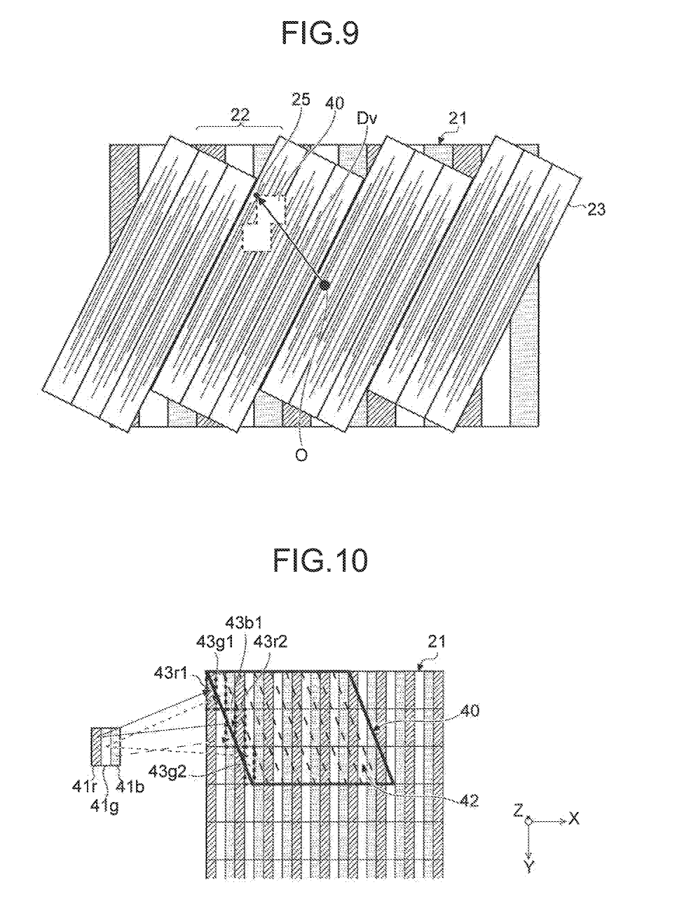

Next, a calculation method of representative ray information will be explained using FIGS. 7 to 9. FIG. 7 is an illustration showing a position relationship in a horizontal direction (a width direction of a rendering space) between the rendering space and a starting position (viewpoint) and an ending position (reference point) of a representative ray number. FIG. 8 is an illustration showing a position relationship in a vertical direction (a height direction of the rendering space) between the rendering space and the starting position (viewpoint) and the ending position (reference point) of the representative ray number. FIG. 9 is an illustration showing a position relationship between a center of the panel and a reference point of a 3D-pixel region. In the following, for the sake of simplification, a case where a width Ww of the rendering space 24 is the same as a width of the panel 21 and a height Wh of the rendering space 24 is the same as a height of the panel 21 will be explained as an example. In such case, a center O of the panel 21 coincides with a center O of the rendering space 24. Furthermore, in the example shown in FIG. 9, it is assumed that a reference point 25 of a 3D-pixel region 40 is assigned to a left top corner of the 3D-pixel region 40, for instance.

In calculation of a representative ray number, firstly, a starting position of a representative ray is calculated using a representative ray number. When the representative ray number is an integer, a position of a reference viewpoint corresponding to the representative ray number is directly used as the starting position of the representative ray, and when the representative ray number has a decimal point, the starting position (a position of the viewpoint 31 shown in FIGS. 7 and 8) corresponding to the representative ray number is calculated by linear interpolation using adjacent reference viewpoints. In the example shown in FIG. 7, by executing linear interpolation using a position of the reference viewpoint #2 corresponding to the ray number ‘2’ and a position of the reference viewpoint #3 corresponding to the ray number ‘3’, a position of the viewpoint 31 corresponding to a representative ray number #2.5 in the horizontal direction is calculated. As shown in FIG. 8, because a position of the reference viewpoints 30 in the vertical direction, i.e., distances from the panel 21 to the viewpoints 30 in the vertical direction are the same, the positions of the viewpoints 31 in the vertical direction can be directly used as a position of the reference viewpoint 30 in the vertical direction.

Next, as shown in FIG. 9, a vector Dv=(Dx,Dy) from the center O of the panel 21 to a left periphery of a target 3D-pixel region 40 is obtained. Then, a vector Dv′=(Dx′,Dy′) representing where the left periphery of the target 3D-pixel region 40 is located on the rendering space 24 is obtained. The vector Dv′ can be obtained by normalizing an X component of the vector Dv by a lateral width of the panel 21 and a Y component of the vector Dy by a vertical width of the panel 21, and then, multiplying the normalized X component by the lateral width Ww of the rendering space 24 and the normalized Y component by the vertical width Wh of the rendering space 24. A position obtained as a result thereof is an ending position of the representative ray, and thereby, it is possible to obtain a directional vector of the representative ray based on the starting position and the ending position.

In this way, it is possible to calculate the representative ray information corresponding to a representative ray number of each quantization unit region 42.

Although the above-described calculation method of representative ray information is based on perspective projection, it is not limited to the perspective projection, and it is also possible to be based on parallel projection. In such case, the vector Dv′ is added to the starting position of the representative ray. Furthermore, it is also possible to combine the perspective projection and the parallel projection. In such case, a component (X component or Y component) to be based on the perspective projection in the components of the vector Dv′ is added to the starting position of the representative ray.

Moreover, in the above-described example, although each lens (or each barrier) is treated as the optical aperture 23, it is not limited to such manner, and it is also possible to define a plurality of lenses (or barriers) as a single virtual lens (or barrier) and treat the virtual lens (or barrier) as the optical aperture 23. In such case also, it is possible to execute the same processes described above.

Moreover, although the left periphery of the 3D-pixel region 40 is defined as the reference in the above description, it is not limited to such manner, and it is also possible to define a center obtained by averaging position coordinates of the left periphery and a right periphery of the 3D-pixel region 40, or the like, as the representative point of the 3D-pixel region 40.

Moreover, although the case where the center of the panel 21 is corresponding to the center O(0,0,0) of the rendering space 24 is explained as an example, also in a case where the center of the panel 21 is shifted from the center O(0,0,0) of the rendering space 24, it is possible to apply the same processes by executing an appropriate coordinate conversion. Although the case where the width Ww of the rendering space 24 is the same as the width of the panel 21 and the height Wh of the rendering space 24 is the same as the height of the panel 21 is explained as an example, also in a case where the width Ww of the rendering space 24 differs from the width of the panel 21 and the height Wh of the rendering space 24 differs from the height of the panel 21, it is possible to apply the same processes by executing an appropriate coordinate conversion. Although the starting position of the representative ray is obtained by the linear interpolation when the representative ray number has a decimal point, an interpolation method is not limited to the linear interpolation, and the other function can be used. For example, a non-linear function such as a sigmoid function can be used.

///Second Calculator

The second calculator 122 calculates a brightness value of each quantization unit region 42 based on the representative ray information calculated by the first calculator 121 and the volume data acquired by the first acquirer 130. As a method of calculating a brightness value, it is possible to use a method such as the well-known ray casting, ray tracing, or the like, in the field of computer graphics. The ray casting is a method of executing rendering by tracing light ray from a viewpoint and integrating color information at an intersection of the light ray and an object. The ray tracing is a method in which reflected light is further considered in the method of ray casting. Because these are the common methods, detailed descriptions thereof will be omitted. In this embodiment, although the volume data is used as model data, other common models in the field of computer graphics such as boundary representation model, or the like, can also be used. In such case, it is also possible to execute rendering using the ray casting or the ray tracing.

///Third Calculator

The third calculator 123 decides a brightness value of each sub-pixel in a sub-pixel group corresponding to each quantization unit region 42 based on the brightness value of each quantization unit region 42 calculated by the second calculator 122. In particular, as shown in FIG. 10, the third calculator 123 replaces values of sub-pixels 43r1, 43r2, 43g1, 43g2 and 43b1 in a sub-pixel group with color components 41r, 41g and 41b of the brightness value calculated by the second calculator 122 with respect to each quantization unit region 42. For example, when the sub-pixels 43g1 and 43g2 in a sub-pixel group represent G components, G component 41g of the brightness value calculated by the second calculator 122 is defined as the G components of the sub-pixels 43g1 and 43g2. By executing such process for each quantization unit region 42, the 3D-image will be generated.

//Data Processor

Next, the data processor 140 of the image processing device 10 will be explained. As shown in FIG. 1, the data processor 140 has a generator 141 and an evaluator 142.

//Generator

The generator 141 decides a representative frequency by executing frequency analysis of the model data acquired by the first acquirer 130 and generates model data for evaluation (hereinafter referred to as evaluation model data) corresponding to the representative frequency. The generator 141 transmits the generated evaluation model data to the 3D-image generator 120 and the clustering processor 110.

//Evaluator

The evaluator 142 receives a 3D-image for each division number which is generated by the 3D-image generator 120 from the evaluation model data, and by evaluating similarities between a 3D-image being reference thereamong (hereinafter referred to as a reference 3D-image) and the other 3D-images, decides a division number to be used by the clustering processor 110 (also referred to as an optimal division number). The decided division number is inputted to the divider 111 of the clustering processor 110, and used for generating a 3D-image to be displayed on the display 20 by the clustering processor 110. The reference 3D-image may be a 3D-image generated using a maximum division number, for instance.

Operation

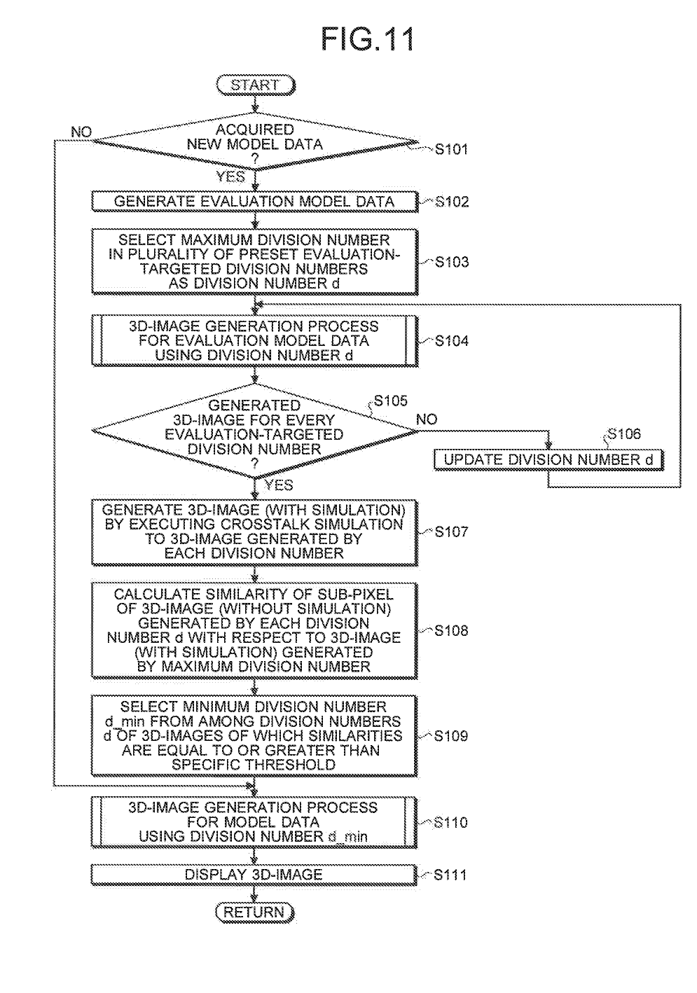

Next, an operation of the image processing device 10 according to the first embodiment will be described in detail with reference to the accompanying drawings. FIG. 11 is a flowchart showing a total operation of an image processing device according to the first embodiment. As shown in FIG. 11, the image processing device 10 determines whether the first acquirer 130 acquires a new model data or not (step S101), and when the new model data is acquired (step S101; YES), the image processing device 10 inputs the new model data to the generator 141 and progresses to step S102. On the other hand, when the new model data is not acquired (step S101; NO), the image processing device 10 progresses to step S109. The model data acquired by the first acquirer 130 can be stored in a storage, or the like.

In step S102, the generator 141 generates an evaluation model data based on the inputted new model data. In particular, the generator 141 executes frequency analysis on the new model data, and decides a representative frequency being a major frequency of the new model data. The representative frequency may be a highest frequency component in frequency components obtained by the frequency analysis. Next, the generator 141 generates the evaluation model data (also referred to as sine wave model data) having a sine wave with respect to the representative frequency. When the model data is a volume data, for instance, the evaluation model data can be generated by fixing one axis among three axes and assigning concentration values to two dimensional concentration data constructed by two axes except for the fixed axis so that a brightness variation has a shape of sine wave. After that, the generator 141 inputs a plurality of evaluation-targeted division numbers being division numbers for rendering of the evaluation mode while inputting the generated evaluation model data to the 3D-image generator 120.

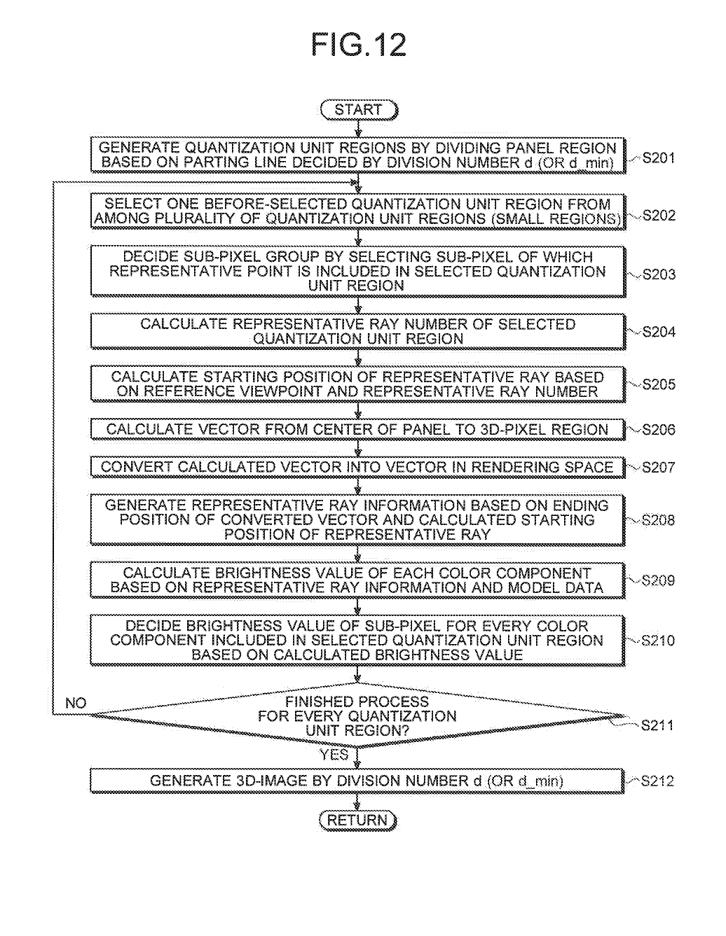

The divider 111 of the clustering processor 110 selects a maximum division number in the inputted evaluation-targeted division numbers as a division number d to be used for generating a 3D-image (step S103). After that, the image processing device 10 executes generation process of 3D-image with respect to the evaluation model data using the division number d selected by the division number 111 (step S104). Details of step S104 will be explained below with FIG. 12.

After the 3D-image for the evaluation model data is generated using the division number d, the image processing device 10 determines whether 3D-images are generated for every evaluation-targeted division number using the evaluation model data (step S105), and when a remaining evaluation-targeted division number being unused for the generation of 3D-image exists (step S105; NO), the divider 111 updates the division number d to the remaining evaluation-targeted division number (step S106), and returns to step S104. On the other hand, every evaluation-targeted division number is used for the generation of 3D-images (step S105; YES), the image processing device 10 progresses to step S107.

The plurality of the evaluation-targeted division numbers can be decided by a method where the division number d is decreased by constant amount from a predetermined maximum division number within a range greater than 1, for instance. For example, when the maximum division number is 16 and the constant amount is 2, the evaluation-targeted division numbers have eight patterns which are 16, 14, 12, 10, 8, 6, 4 and 2. In such case, step S104 described above will be repeated eight times. As a result, eight 3D-images are generated with respect to the evaluation model data.

In step S107, the evaluator 142 generates a crosstalk-adjusted 3D-images by executing a simulation of optical intermixing of brightness (hereinafter referred to as crosstalk) to the number of the evaluation-targeted division numbers (here, eight) of the 3D-images (hereinafter referred to as crosstalk simulation). In the crosstalk simulation in this description, considering a case where each sub-pixel is observed in a direction represented by a parallax number, a state where the target sub-pixel is observed as a sub-pixel with information different from that about the original brightness of the target sub-pixel is simulated as a result of crosstalk of brightness originated in sub-pixels except for the target sub-pixel. As the crosstalk simulation, for instance, there is a method where degrees of crosstalk between sub-pixels are measured by measuring relationships between angle and brightness under a condition where a sub-pixel corresponding to each parallax number is turned on, and in a simulation, a weight linear sum is calculated while the measured degrees are used as mixture ratios.

Next, the evaluator 142 evaluates a similarity between the 3D-image generated using the maximum division number before the crosstalk simulation and the 3D-image generated using each division number after the crosstalk simulation (step S108). Optimally, the evaluation of similarities is executed in a sub-pixel basis. For calculating similarities, a PSNR (peak signal-to-noise ratio) commonly used as an evaluation indicator of a rate of image deterioration can be used, for instance.

Next, the evaluator 142 selects a division number (evaluation-targeted division number) d_min corresponding to a 3D-image (with simulation) of which similarity to a 3D-image (without simulation) generated using a maximum division number in the 3D-images (with simulation) of every division number is equal to or greater than a specific threshold and of which division number is smallest among the division numbers of the 3D-images (with simulation) of which similarities to the 3D-image (without simulation) generated using the maximum division number are equal to or greater than the specific threshold (step S109). For example, in the above-described example, when the evaluation-targeted division numbers corresponding to the 3D-images (with simulation) of which similarities to the 3D-image (without simulation) generated using the maximum division number are equal to or greater than the specific threshold are 10, 12, 14 and 16, a division number 10 being minimum in these division numbers is selected as the division number d_min in step S109. The selected division number d_min is inputted to the divider 111.

In step S110, the image processing device 10 executes generation process of a 3D-image for the model data using the division number d_min selected by the evaluator 142. Details in step S110 will be described with the details in step S104 below using FIG. 12.

Next, the image processing device 10 displays the 3D-image generated from the model data using the division number d_min by inputting the 3D-image generated in step S110 to the display 20. After that, the image processing device 10 may finish the operation shown in FIG. 11.

In the above-described description, the method of determining the representative frequency is not limited to the above-described method. For example, a method where a frequency with a greatest frequency component is defined as the representative frequency, a method where a frequency calculated by multiplying a highest frequency by a weight w is defined as the representative frequency, a method where a frequency necessary for representation is obtained in response to a request from the observer such as “want to see 1 mm things”, or the like, and the obtained frequency is defined as the representative frequency, or the like, can be used.

For a method of measuring a degree of crosstalk, aside from the above-described method, it is also applicable that relationships between angle and brightness are measured under a condition where sub-pixels of which parallax numbers are included in a specific range are turned on, and the measured values are defined as the degrees of crosstalk of the turned-on sub-pixels. As the similarity, various kinds of general evaluation values of image processing except for the PSNR can be used. The crosstalk simulation is not essential. When a trend of similarity depending on the presence or absence of crosstalk is less varied, e.g. when it is previously apparent that a degree of crosstalk is sufficiently small, or the like, it is possible to omit the crosstalk simulation.

Next, a 3D-image generation process shown in step S104 or S110 of FIG. 11 will be described in detail using FIG. 12. FIG. 12 is a flowchart showing an example of a 3D-image generation process shown in step S104 or S110 of FIG. 11. As shown in FIG. 12, in a 3D-image generation process for the evaluation model data or the model data using the division number d or d_min, firstly, the divider 111 of the clustering processor 110 calculates a plurality of quantization unit regions (also referred to as small regions) 42 by dividing a display surface (panel region) of the panel 21 according to the parting lines 41 decided based on the division number d or d_min (step S201). Specifically, the divider 111 calculates the parting lines 41 for each 3D-pixel region 40 based on the division number d or d_min, and by separating each 3D-pixel region 40 based on the calculated parting lines 41, calculates the plurality of quantization unit regions 42. Information about the calculated quantization unit regions 42 is inputted to the selector 112 as region parameters. The definition of the 3D-pixel region 40 being a reference for calculation may be the same as previously described. At this time, the 3D-pixel regions 40 are defined so as not to overlap one another depending on each optical aperture.

Next, the selector 112 selects one before-selected quantization unit region 42 in the calculated quantization unit regions 42 (step S202). To a method of selecting the quantization unit region 42, various kinds of methods such as round-robin, or the like, can be applied. Then, the selector 112 selects every sub-pixel each of which representative point is included in the selected quantization unit region 42, and defined a sub-pixel group by grouping the selected sub-pixels (step S203). Information about the sub-pixel group in each defined quantization unit region 42 is inputted to the 3D-image generator 120.

Next, the first calculator 121 of the 3D-image generator 120 calculates a representative ray number of the selected quantization unit region 42 (step S204). A method of calculating the representative ray number can be the same as previously described.

Next, the first calculator 121 calculates representative ray information about a representative ray based on the calculated representative ray number. In particular, the first calculator 121, firstly, calculates a starting position (view position) of the representative ray of the selected quantization unit region 42 based on the calculated representative ray number and preset positions of the reference viewpoints 30 (step S205). Next, the first calculator 121 calculates a vector Dv from a center O of the panel 21 to a reference point (left top corner, for instance) of the 3D-pixel region 42 with respect to the selected quantization unit region 42 (step S206). Then, the first calculator 121 converts the vector Dv calculated for the panel 21 into a vector Dv′=(Dx′,Dy′) in the rendering space 24 (step S207). That is, the first calculator 121 obtains the vector Dv′=(Dx′,Dy′) representing a position of the reference point of the 3D-pixel region 40 in the rendering space 2.

Here, as described above, the width Ww of the rendering space 24 is the same as the width of the panel 21, the height Eh of the rendering space 24 is the same as the height of the panel 21, and the center O of the panel 21 coincides with the center O of the rendering space 24. Therefore, the vector Dv′ can be obtained by normalizing an X-coordinate of the vector Dx by the lateral width of the panel 21 and a Y-coordinate of the vector Dy by the vertical width of the panel 21, and then multiplying the normalized X-coordinate and Y-coordinate by the lateral width Ww and the vertical width Wh of the rendering space 24, respectively.

Then, the first calculator 121 calculates an ending position of the representative ray from the converted vector Dv′, and obtains a vector of the representative ray from the calculated ending position and the starting position calculated in step S205. Thereby, in the first calculator 121, the representative ray information about the representative ray number of the selected quantization unit region 42 is generated (step S208). The representative ray information may include the starting position and the ending position of the representative ray. The starting position and the ending position may be coordinates in the rendering space 24.

Although the process of step S208 corresponds to the prospective projection, the parallel projection can also be used. In such case, the vector Dv′ is added to the starting position of the representative ray. Furthermore, it is also possible to combine the parallel projection and the prospective projection. In such case, a component to be prospectively projected among components of the vector Dv′ is added to the starting position of the representative ray.

After the representative ray information is calculated as described above, next, the second calculator 122 calculates a brightness value for each quantization unit region 42 based on the representative ray information and the volume data (step S209). As a method of calculating brightness values, a method such as the above-described ray casting, ray tracing, or the like, can be used.

Next, the third calculator 123 decides a brightness value of each sub-pixel in a sub-pixel group corresponding to the selected quantization unit region 42 based on the brightness value for every quantization unit region 42 calculated by the second calculator 122 (step S210). A method of deciding a brightness value of each sub-pixel can be the same with the method described above using FIG. 10.

After that, the 3D-image generator 120 determines whether the above-described processes are finished for every quantization unit region 42 or not (step S211), and when the processes have not been finished (step S211; NO), the 3D-image generator 120 returns to step S202, and executes the following processes until the processes are finished for every quantization unit region 42. On the other hand, when the processes have been finished for every quantization unit region 42 (step S211; YES), the third calculator 123 generates a 3D-image using the decide brightness values (step S212), and then, returns to the operation shown in FIG. 11.

Generally, there are a plurality of 3D-pixel regions 40. Each 3D-pixel region 40 is further divided by a specific division number. Therefore, there are a plurality of the quantization unit regions 42 which are units of actual process. For example, when there are one hundred 3D-pixels 40 and the division number is eight, there are eight hundred (800=100×8) quantization unit regions 42. Therefore, steps S202 to S210 in FIG. 12 will be repeated eight hundred times. That is, a calculation amount in the first embodiment is decided based on the number of the 3D-pixels 40 and the division number, but not based on the number of sub-pixels of the display 20. Therefore, in the first embodiment, it is possible to adjust a calculation amount arbitrarily. For example, when the display 20 has ten thousand sub-pixels, the frequency of renderings in a common technique becomes ten thousand times being the same with the number of sub-pixels. On the other hand, in the first embodiment, because rendering is executed once for each quantization unit region 42, it is possible to generate a 3D-image by eight hundred renderings. Furthermore, in the first embodiment, when the number of sub-pixels of the display 20 is increased, although the number of sub-pixels included in each quantization unit region 42 is increased, the frequency of renderings is not changed. This is an acceptable aspect for estimating a process cost in order to design hardware. Moreover, because the processes in the first embodiment are independent, respectively, while each quantization unit regions 42 is defined as a unit, there is an aspect such that an effect of parallel processing is great.

Generally, 3D-pixel regions 40 are predetermined based on a layout of optical apertures. Therefore, a calculation amount in the first embodiment can be adjusted using the division number. For example, by decreasing the division number, the width Td of each quantization unit region 42 in the X-axis direction is increased, and as a result, because the number of sets of the quantization unit regions 42 is reduced, the calculation amount is reduced, and a processing speed is improved. On the other hand, when the division number is great, because the number of sets of the quantization unit regions 42 is increased, it is possible to display a higher-quality image with respect to movement of viewpoint.

As described above, in the first embodiment, it is possible to adjust a relationship between processing speed and image quality with movement of viewpoint by adjusting the division number, and therefore, it is possible to execute flexible adjustment such that the division number is adjusted so that processing speed is given priority in a low-end device and image quality is given priority in a high-end device with high computing power such as a personal computer, or the like.

By adjusting the division number, it is also possible to adjust the image quality when a viewpoint stands still. In a 3D-display, when considering image quality at a certain viewpoint, because a degree of crosstalk is depended on a specification of hardware, it is difficult to dissolve the crosstalk completely. On the other hand, when the division number is the small in the first embodiment, because it is possible to assign the same information to the light rays emitted closely to one other, the crosstalk will not be recognized as image blurring, and as a result, it is possible to improve the image quality when a viewpoint stands still. That is, in the first embodiment, reduction of the division number can be applied to a case where processing speed has no trouble because power for computing light ray is enough. In this way, in the first embodiment, it is possible to adjust a relationship between image quality without movement of viewpoint and image quality with movement of viewpoint.

As described above, according to the first embodiment, because there is no interpolation process in every process, compared with a prior method where 3D-images are generated while parallax images are interpolated, it is possible to provide high-quality 3D-images to the observer. Furthermore, because the processes are not executed in a sub-pixel basis, it is possible to adjust a balance between image quality and processing speed based on computing power of a device. Moreover, because the balance is decided based on image quality of representation-targeted frequency, it is consistently possible to improve the processing speed while maintaining a desired image quality.

### Alternate Example 1 of First Embodiment

In the operations of the data processor 140 exampled in the first embodiment, the operations from step S102 to step S108 in FIG. 11 can be previously executed. In such case, data of similarity (hereinafter referred to as similarity data) obtained by the precedent execution is stored in a specific storage, and selectively read out depending on the situation. In the following, an image processing device, a 3D-image display device, a method of image processing and a program product thereof according to the alternate example 1 of the first embodiment will be described in detail with reference to the accompanying drawings.

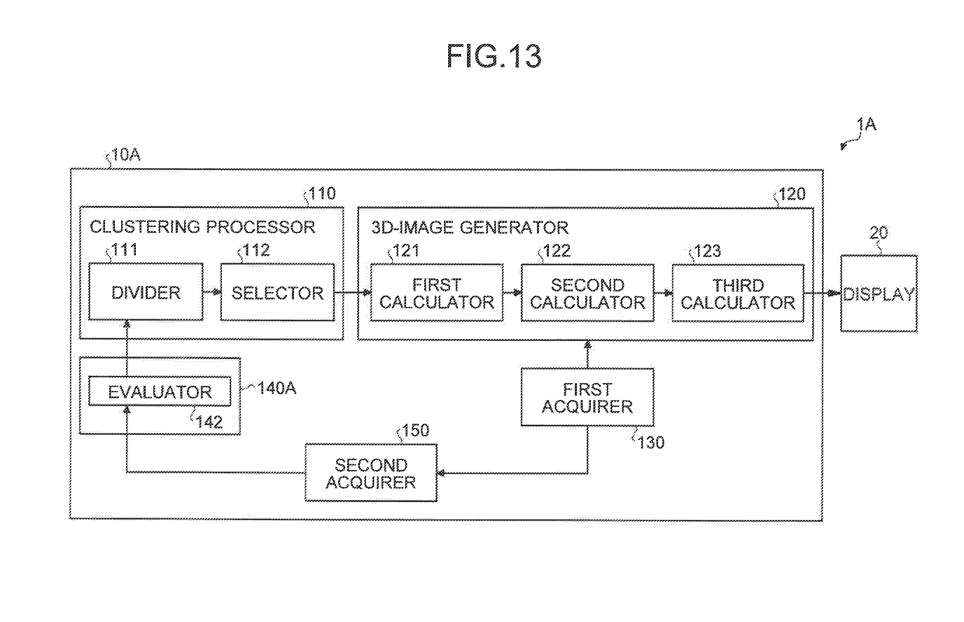

FIG. 13 is a block diagram showing a structure example of a 3D-image display device according to the alternate example 1. As shown in FIG. 13, the 3D-image display device 1A according to the alternate example 1 has the same structures as the 3D-image display device 1 shown in FIG. 1 except for the data processor 140 is replaced with a data processor 140A without the generator 141, and the device LA further has a second acquirer 150.

Second Acquirer

The second acquirer 150 acquires similarity data stored for every frequency at predetermined regular intervals. The similarity data is data generated by grouping similarities obtained by executing the processes of steps S102 to S108 in FIG. 11 while changing representative frequencies at regular intervals for each representative frequency. Because similarities of which number is the same as the evaluation-targeted division number are calculated for every frequency, for instance, in a case where the evaluation-targeted division numbers have 8 patterns and the representative frequencies has 5 patterns, 40(=8×5) similarities will be stored.

As with step S102 described above, the second acquirer 150 decides a representative frequency, and acquires a similarity corresponding to a nearest frequency from among the similarity data. As a result, in the above-described case, for instance, 8 similarities are acquired.

Data Processor

The data processor in the alternate example 1 executes the process of step S109 of FIG. 11.

As described above, according to the alternate example 1, because a part of the processes which is executed at the time of reading the model data in the first embodiment is executed previously, it is possible to reduce a cost at the time of reading new model data. Because the other structures and operations are the same as those of the above-described embodiment, redundant explanations thereof will be omitted.

### Alternate Example 2 of First Embodiment

As described above, the model data being a process target in the first embodiment is not limited to volume data. In the alternate example 2, a case where model data is a combination of an image with a single viewpoint (hereinafter referred to as a reference image) and depth data corresponding thereto will be explained.

A 3D-image display device according to the alternate example 2 can have the same structure as that of the 3D-image display device 1 shown in FIG. 1. However, in the alternate example 2, the first calculator 121 and the second calculator 122 execute the following operations, respectively.

First Calculator

In the alternate example 2, the first calculator 121 executes the same operation shown in steps S202 to S208 of FIG. 12 in the first embodiment. Here, the first calculator 121 uses camera positions instead of the reference viewpoints 30. That is, the first calculator 121 calculates a camera position (starting position) of a representative ray using a camera position of each quantization unit region, and calculates a distance between the camera position of the representative ray and the center O of the panel 21.

Second Calculator

The second calculator 122 calculates a brightness value of each sub-pixel from a reference image and depth data corresponding to each pixel in the reference image based on the distance between the camera position and the center O of the panel 21 calculated by the first calculator 121. In the following, an operation of the second calculator 122 in the alternate example 2 will be described. In the following, for the sake of simplification, a case where the reference image is an image corresponding to a ray number ‘0’, the width Ww of the rendering space 24 is the same as a lateral width of the reference image, the height Wh of the rendering space 24 is the same as a vertical width of the reference image, and a center of the reference image coincides with the center O of the rendering space 24, i.e., a case where the panel 21 and the reference image are arranged on the rendering space 24 with the same scale, will be explained as an example.

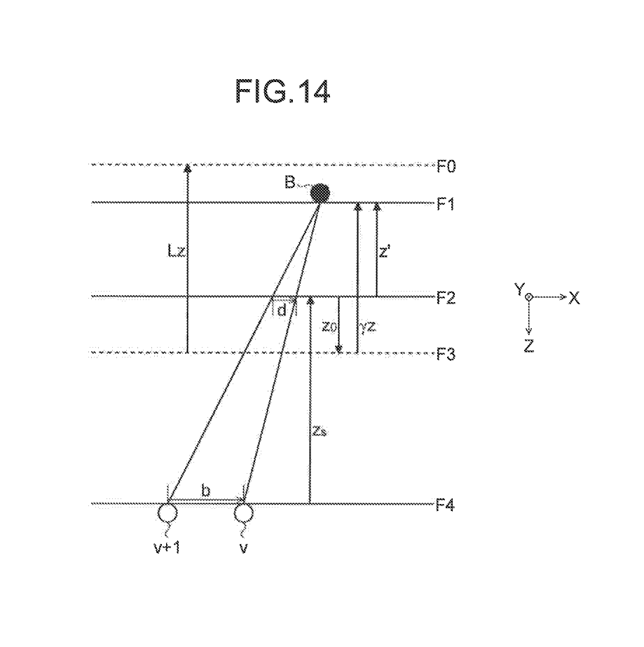

FIG. 14 is an illustration for explaining a process of the second calculator in the alternate example 2. As shown in FIG. 14, in the alternate example 2, firstly, the second calculator 122 obtains a parallax vector d in each pixel of the reference image (hereinafter referred to as a reference pixel set). The parallax vector d is a vector indicating a direction and a distance of parallel shift of a pixel in order to achieve a specific projection amount. A parallax vector d for a certain pixel can be obtained using the following formula (3).

$$γ = \frac{Lz}{{z}_{max}} \\ {z}^{′} = γ {z}_{d} - {z}_{0} \\ d \text{:} b = {z}^{′} \text{:} ( {z}_{s} + {z}^{′} ) \\ d = b ( \frac{{z}^{′}}{{z}_{s} + {z}^{′}} ) \qquad ( 3 )$$

In the formula (3), Lz indicates a depth size of the rendering space 24, zₘₐₓ indicates an upper limit of the depth data, z₀ indicates a projection length in the rendering space 24, b indicates a vector between adjacent camera positions, and zₛ indicates a distance from a camera position to the reference image (panel 21) in the rendering space 24. Furthermore, in FIG. 14, F0 indicates a position of a plane corresponding to the upper limit of the depth data, F1 indicates a position of an object B in the depth data, F2 is a position of the panel 21, F3 indicates a position of a plane corresponding to a lower limit of the depth data, and F4 indicates a position of a plane on which the reference viewpoints (v+1, v, . . . ) are arranged.

Next, the second calculator 122 obtains a position vector p′(x,y) of each pixel in the rendering space 24 after the reference image is translated based on the depth data. The position vector p′ can be obtained using the following formula (4).

p′(x,y)=p(x,y)+−nᵥd(x,y) (4)

In the formula (4), x and y are pixel unit X-coordinate and Y-coordinate in the reference image, nᵥ is a ray number of a sub-pixel being a target for obtaining a brightness value, p(x,y) is a position vector of each pixel in the before-shifted rendering space 24, and d(x,y) is a parallax vector d calculated from depth data corresponding to a coordinate (x,y) pixel.

After that, the second calculator 122 specifies a position vector p′ of which position coordinate is proximate to Dx′ among the obtained position vectors p′(x,y), and decides a pixel corresponding to the specified position vector p′. Color components corresponding to sub-pixels of the decided pixel are target brightness values. Here, when there are a plurality of pixels of which position coordinates are proximate to Dx′, a pixel with a greatest projection amount may be used.

In the alternate example 2, although the parallax vectors d are obtained for every pixel in the reference image, when the camera positions are arrayed along the X-axis, for instance, it is also possible that pixels including the X component Dx′ in the vector Dv′ obtained by the first calculator 121 are obtained, and the parallax vectors d are obtained using pixels with a Y-coordinate being the same as that of the pixels including the X component Dx′ in a coordinate system of the image. On the other hand, when the camera positions are arrayed along the Y-axis, it is also possible that pixels including the X component Dx′ are obtained, and the parallax vectors d are obtained using pixels with an X-coordinate being the same as that of the pixels including the X component Dx′ in the coordinate system of the image.

When a maximum absolute value |d| of a parallax vector d in the reference image is previously apparent, it is also possible to obtain the parallax vectors d using pixels included in a region from the X component Dx′ to plus or minus |d|. Furthermore, by combining the above-described methods, a region for calculating the parallax vectors can be confined.

As described above, according to the alternate example 2, even when the model data is a combination of an image with a single viewpoint and depth data corresponding thereto, and even when the model data is not refined 3D data, it is possible to generate a 3D-image with a minimum interpolation process. Thereby, it is possible to provide a high-quality 3D-image to the observer. Because the other structures and operations are the same as those of the above-described embodiment, redundant explanations thereof will be omitted.

### Second Embodiment

Next, an image processing device, a 3D-image display device, a method of image processing and a program product thereof according to a second embodiment will be described in detail. In the following, as for the same structures as those of the first embodiment or the alternate examples thereof, the same reference numbers will be arranged, and redundant explanations thereof will be omitted.

In the second embodiment, a view position of the observer is obtained, and parameters of the panel 21 are corrected based on the view position so that the observer is consistently included in a visible range.

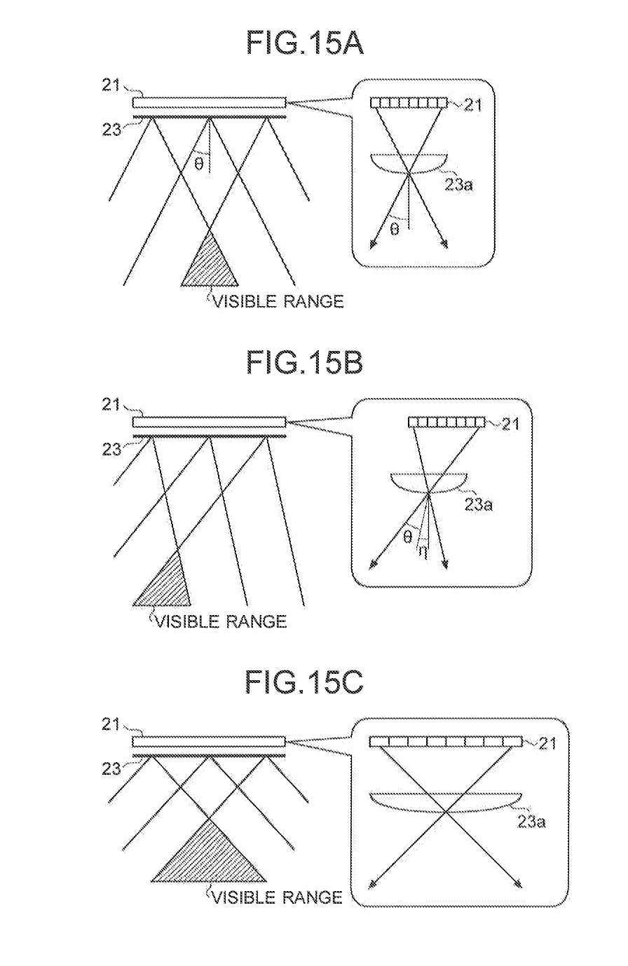

FIGS. 15A to 15C are illustrations showing a position relationship between a panel and an optical element according to the second embodiment. In a case where a position relationship between the panel 21 and an optical element 23a in the optical aperture 23 is a condition shown in FIG. 15A, when the panel 21 and the optical aperture 23 are shifted with respect to each other in the horizontal direction (X direction), the visible range is shifted to a direction that is the same as a direction of the shift, as shown in FIG. 15B. In the example shown in FIG. 15B, the shift of the optical aperture 23 leftward along a plane of a paper makes the light ray shift by as much as n from the position in the condition shown in FIG. 15A, and thereby, the visible range shifts leftward. That is, when the panel 21 and the optical element 23a are physically shifted with respect to one another, the visible range is not located at the front of the panel 21, and is shifted in any direction. Therefore, in a pixel mapping in Reference 1 which is C. V. Berkel, “Image preparation for 3D-LCD,” Proc. SPIE, Stereoscopic Displays and Virtual Reality Systems, vol. 3639, pp. 84-91, 1999, by considering an offset koffset, even if the panel 21 and the optical element 23a are shifted with respect to one another, the visible range can be located at the front of the panel 21. in the second embodiment, by further correcting the physical offset koffset, the visible range is shifted to a view position of the observer. For this purpose, a shift of a visible range caused by an offset of the above-described position relationship between the panel 21 and the optical element 23a is used. When it is assumed that a position of a lens is fixed to the original position, a shift of a visible range depending on the position relationship between the panel 21 and the optical element 23a can be considered as the same as the shift of the visible range in a direction opposite to the direction of the shift of the panel 21 and the optical element 23a. Therefore, the visible range is purposely shifted by correcting the offset koffset so that the visible range includes a view position of the observer.

In a case where a position relationship between the panel 21 and the optical element 23a is a condition shown in FIG. 15A, as shown in FIG. 15C, when the width Xn on the panel 21 corresponding to one optical aperture 23 is expanded, the visible range comes close to the panel 21. That is, in FIG. 15C, a width of an element image becomes greater than that in FIG. 15A. Therefore, by correcting the value of the width Xn so that the value is increased or decreased from an actual value, it is possible to make a degree of position correction of the visible range in a vertical direction (direction of Z-axis) by the pixel mapping continuous (fine). Thereby, the position of the visible range can be changed continuously in the vertical direction (direction of Z-axis) while the prior art can change the position of the visible range only discretely by changing parallax images in the prior art. As a result, even if the observer stands at any position, it is possible to adjust the visible range to an appropriate position.

As described above, by properly correcting the offset koffset and the width Xn, it is possible to continuously change the position of the visible range both in the horizontal direction and the vertical direction. Thereby, even if the observer stands at any position, it is possible to arrange the visible range conforming to the position of the observer.

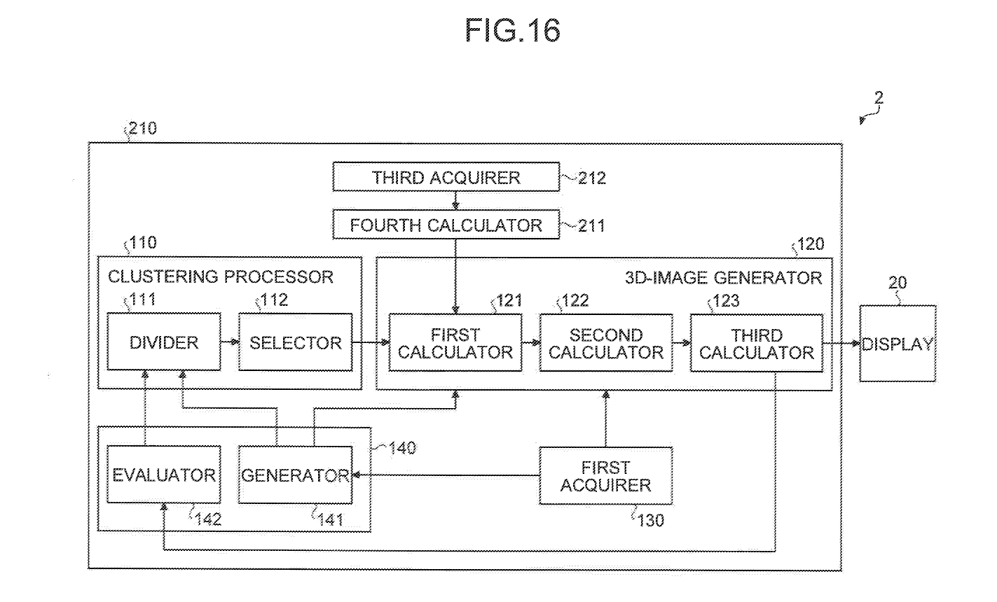

FIG. 16 is a block diagram showing a structure example of a 3D-image display device according to the second embodiment. As shown in FIG. 16, a 3D-image display device 2 according to the second embodiment has a third acquirer 212 and a fourth calculator 211 in addition to the same structure as that of the 3D-image display device 1 shown in FIG. 1.

Third Acquirer

The third acquirer 212 acquires a position of the observer in a visible region in the real space as a 3D coordinate. For acquisition of a position of the observer, for instance, devices such as radar, sensor, or the like, in addition to imaging devices such as visible camera, infrared camera, or the like, can be used. The third acquirer 212 acquires the position of the observer using the well-known technique based on information obtained by these devices (which is an image when the device is camera).

For example, when a visible camera is used, by analyzing obtained images, detection of observer and calculation of a position of the observer are executed. When a radar is used, by executing a signal processing of obtained radar signals, detection of observer and calculation of a position of the observer are executed.

In the observer at the person detection and the position calculation, it is applicable to detect a certain object capable of being determined as a person such as a face, a head, parts of the body, a marker, or the like. Furthermore, it is also possible to detect positions of eyes of the observer. A method of detecting observer is not limited to the above-described methods.

Fourth Calculator

To the fourth calculator 211, the information about the view position of the observer acquired by the third acquirer 212 and panel parameters are inputted. The fourth calculator 211 corrects the panel parameters based on the inputted information about the view position.

Here, a method of correcting panel parameters based on information about a view position will be explained. In correction of the panel parameters, the offset koffset in the direction of the X-axis between the panel 21 and the optical aperture 23 and the horizontal width Xn of the optical element (lenticular lens, parallax barrier, or the like) constructing the optical aperture 23 on the panel 21 are corrected based on the view position. According to such correction, it is possible to shift the visible range of the 3D-image display device 2. In a case where the method of Reference 1 is applied to the pixel mapping, for instance, by the panel parameters are corrected as shown in the following formula (5), it is possible to shift the visible range to a desired position.

koffset=koffset+r_{—}koffset

Xn=r_{—}Xn (5)

In the formula (5), r_koffset indicates a correction amount for the offset koffset. A correction amount for the horizontal width Zn is indicated as r_Xn. A calculation method of these correction amounts will be described later on.

In the formula (5), although a case where the offset koffset is defined as an offset of the panel 21 with respect to the optical aperture 23, when the offset koffset is defined as an offset of the optical aperture 23 with respect to the panel 21, r_koffset is indicated by the following formula (6). Here, in the formula (6), the correction for the horizontal width Xn is the same as the formula (5).

koffset=koffset−r_{—}koffset

Xn=r_{—}Xn (6)

The correction amount r_koffset and the correction amount r_Xn (hereinafter referred to as mapping control parameters) are calculated by the following method.

The correction amount r_koffset is calculated from an X-coordinate of the view position. In particular, the correction amount r_koffset is calculated by the following formula (7) using an X-coordinate of a current view position, a visual distance L being a distance from the view position to the panel 21 (or lens), and a gap g being a distance from the optical aperture 23 (or a principal point P in a case of using lens) to the panel 21. Here, the current view position can be obtained based on information obtained by a CCD camera, an object sensor, or the like, an acceleration sensor configured to detect a direction of gravitational force, or the like.

$$r\_koffest = \frac{X \times g}{L} \qquad ( 7 )$$

The correction amount r_Xn can be calculated based on a Z-coordinate of the view position using the following formula (8).

Here, lens_width indicates a width in a case where the optical aperture 23 is cut off along the direction of the X-axis (longitudinal direction of lens).

$$r\_Xn = \frac{Z \times g}{Z} \times lens\_width \qquad ( 8 )$$

3D-Image Generator

The 3D-image generator 120 calculates a representative ray of each sub-pixel group based on the ray number of each sub-pixel calculated by the fourth calculator 211 and the information about the sub-pixel groups using the corrected panel parameters, and then, executes the same operations as that of the first embodiment.

However, as the alternate examples of the first embodiment, when the model data is the combination of the reference image and the depth data, the second calculator 122 shifts the reference image based on the depth data and the representative ray number, and calculates a brightness value of each sub-pixel group from the shifted reference image.

As described above, in the second embodiment, because the ray numbers are corrected based on the view position of the observer with respect to the panel 21, regardless of the positions of the observer, it is possible to provide a high-quality 3D-image. Because the other structures and operations are the same as those of the above-described embodiment, redundant explanations thereof will be omitted.

### Third Embodiment

The 3D-image display devices according to the above-described embodiments can be used as a monitoring device for observing or diagnosing a subject such as humans, animals, plants, or the like, for instance. In such case, depending on a region and a method of observation or diagnostication, a resolution required for a displayed 3D-image, and so forth, may be changed. In the above-described embodiments, it is also possible to structure a 3D-image display device so that the division number, the representative frequency, an evaluation value of S/N, and so forth, are switched depending on a region and a method of observation or diagnostication.

A 3D-image display device according to the third embodiment can be the same as that of the above-described embodiments. However, in the third embodiment, the evaluation-targeted division number given to the divider 111, the representative frequency decided by the generator 141, and the evaluation value of crosstalk simulation calculated by the evaluator 142 are switched depending on a region, a method, or the like, of observation or diagnostication selected by the observer.

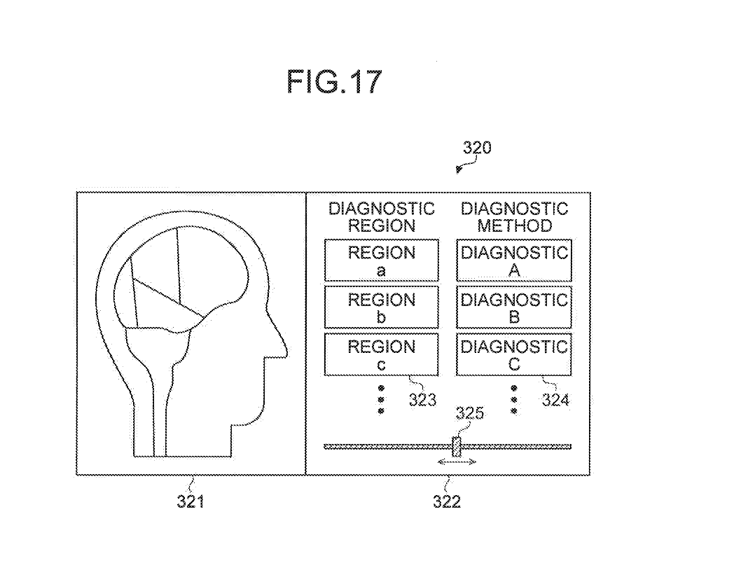

FIG. 17 is an illustration showing an example of a screen displayed on a display according to a third embodiment. As shown in FIG. 17, a display screen 320 displayed on the display 20 includes a first display area 321 for displaying a 3D-image generated by the image processing device 10 stereoscopically, and a second display area 322 for displaying a user interface for inputting operations by the observer.

The user interface displayed on the second display area 322 may include region selection bottoms 323 for selecting a region to be observed or diagnosed by the observer, method selection bottoms 324 for selecting a method of observation or diagnostication by the observer, a resolution adjustment slider 325 for adjusting a resolution of the image displayed on the first display area 321 by the observer, or the like, for instance.

The observer can adjust the displayed 3D-image depending on a purpose of observation or diagnostication arbitrarily by operating the region selection bottoms 323, the method selection bottoms 324 and the resolution adjustment slider 325 using a pointing device such as a mouse, a touchscreen, or the like, for instance.

Operation information inputted by the observer is inputted to the image processing device 10. The image processing device 10 adjusts the division number to be used by the divider 111, the representative frequency to be decided by the generator 141, the evaluation value to be decided by the evaluator 142, or the like, depending on the inputted operation information.

Because the other structures and operations are the same as those of the above-described embodiment, redundant explanations thereof will be omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. A 3D-image display device capable of displaying a 3D-image, the device comprising:
a display panel including a plurality of sub-pixels;
an optical aperture placed opposite the display panel;
a divider that divides a region on the display panel into division numbers differing from each other to generate small regions;
a generator that generates 3D-images based on the small regions by using a model data in which a shape of a 3D object is represented, each 3D-image corresponding to one of the division numbers; and
a data processor that selects a 3D-image to be displayed on the display panel by evaluating the 3D-image corresponding to each division number.

2. The device according to claim 1, wherein the data processor calculates similarities between the 3D-images for each division number, and decide the division number to be used by the divider for the generation of the display-targeted 3D-image based on the calculated similarities.

3. The device according to claim 1, wherein
the data processor includes a generator configured to generate an evaluation model data by executing a frequency analysis of the model data, and
the generator generates the 3D-image for each division number from the evaluation model data based on the small regions depending on the division numbers, and generate the display-targeted 3D-image from the model data based on the small regions generated by dividing the region on the panel based on the division number to be used for the generation of the display-targeted 3D-image decided by the evaluator.

4. The device according to claim 2, wherein the evaluator acquires numerical data indicating the similarities between the 3D-image for each division number, and decide the division number to be used for the generation of the display-targeted 3D-image by the divider based on the acquired similarities.

5. The device according to claim 2, wherein the evaluator corrects the 3D-images while considering crosstalk caused by a divergence of a light ray into a space, and calculate the similarities using the corrected 3D-images for each division number.

6. The device according to claim 1, wherein the division numbers are natural numbers greater than one.

7. The device according to claim 2, wherein the evaluator decides a minimum division number in the division numbers of which similarities of corresponding 3D-images are equal to or smaller than a specific threshold as the division number to be used by the divider for the generation of the display-targeted 3D-image.

8. The device according to claim 2, wherein the evaluator calculates the similarities using the PSNR (peak signal-to-noise ratio).

9. The device according to claim 1, wherein the model data is one of a spatial partitioning model, a boundary representation model and a combination of depth information and at least one viewpoint image.

10. The device according to claim 1, wherein
the generator includes:
a first calculator which decides one or more representative rays each of which represents a sub-pixel corresponding to each small region; and
a second calculator which decides a brightness value of the sub-pixel corresponding to each small region based on color information at an intersection of the model data and the representative ray.

11. A method of displaying a 3D-image on a display with a display panel including a plurality of sub-pixels and an optical aperture placed opposite the display panel, the method including:
generating, by dividing a region on the display panel based on different division numbers, small regions depending on the division numbers;
generating a 3D-image for each division number based on the small regions depending on the division numbers; and
deciding, by evaluating the 3D-image for each division number, a division number to be used by the divider for generation of a display-targeted 3D-image.

12. An image processing device capable of generating a 3D-image, which is to be displayed on a display with a display panel including a plurality of sub-pixels and an optical aperture placed opposite the display panel, the device comprising:
a divider that divides a region on the display panel into division numbers differing from each other to generate small regions;
a generator that generates 3D-images based on the small regions by using a model data in which a shape of a 3D object is represented, each 3D-image corresponding to one of the division numbers; and
a data processor that selects a 3D-image to be displayed on the display panel by evaluating the 3D-image corresponding to each division number.
